(19) United States
(12) Patent Application Publication
(10) Pub. No.: US 2011/0205853 A1
(43) Pub. Date: Aug. 25, 2011

(54) Electronic watch, method of processing the same, and program therefor

(76) Inventor: Shotaro Kamiyama, Chiba-shi (JP)

(21) Appl. No.: 12/931,994

(22) Filed: Feb. 15, 2011

(30) Foreign Application Priority Data
Feb. 18, 2010 (JP) 2010-033925

(51) Int. Cl. G04C 3/00

(52) U.S. Cl. 368/80

(57) ABSTRACT

An electronic watch compares a value counted by an internal counter, which is read by the internal counter when a driving timing signal of a chronograph hand is output, with a counted value stored in a counted value storage unit in advance and, if they match, determines that a driving timing signal of the time-of-day hand and the driving timing signal of the chronograph signal overlap with each other, and performs a process of delaying or advancing the driving timing of the time-of-day hand.

### BACKGROUND OF THE INVENTION

1. Field of the Invention

The present invention relates to an electronic watch having a plurality of hands and a plurality of motors configured to move the hands respectively, a method of processing the same, and a program therefor.

2. Related Art

As an electronic watch configured to drive a plurality of hands (second hand, hour hand, and minute hand) by a plurality of motors, JP-A-2005-233617 discloses a configuration in which appearance of movement of hands is improved by avoiding overlap of pulses if an output of a drive pulse of a second motor is made during an output of a drive pulse of a first motor by making the drive pulse from the second motor wait until the output of the drive pulse from the first motor is completed.

Even in a watch having a chronograph function which allows free advance and stop of a hand (hereinafter, referred to as a chronograph hand) such as a stop watch, if the action timing of the chronograph hand is overlapped with the action timing of the second hand or the minute hand, (hereinafter, referred to as time-of-day hands), a normal action is not achieved because the voltage of a battery lowers. Therefore, when the action timing of the chronograph hand and the action timings of the time-of-day hands are overlapped, control is performed to shift the action timing of either one of them so as to avoid the overlap of the action timings.

However, since the action timing of the chronograph hand is stopped for a moment in the course of movement in the control as described above, there arises a problem that the movement of the hand is fluctuated.

### SUMMARY OF THE INVENTION

It is an aspect of the present application to provide an electronic watch having a plurality of hands and a plurality of motors for moving the plurality of hands respectively, such as a watch having a chronograph function, in which fluctuations of movements of hands can be eliminated, and a method of processing the same, and a program therefor.

In order to achieve the above-described aspect, the application provides an electronic watch having a plurality of hands and a plurality of motors configured to move the hands respectively, including, a reference clock output unit configured to output a reference clock indicating a reference of the movement of the hand at a reference cycle on the basis of the number of the reference cycles per second, a time-of-day hand driving timing generating unit configured to output a driving timing signal of a time-of-day hand among the plurality of hands at every time-of-day driving cycle on the basis of the reference clock, an action detection unit configured to detect an action starting signal of a chronograph hand among the plurality of hands; a chronograph hand driving timing generating unit configured to output a driving timing signal of the chronograph hand at every chronograph hand driving cycle on the basis of the reference clock after the detection of the action starting signal, a timing overlap determining unit configured to determine whether or not the driving timing signal of the time-of-day hand and the driving timing signal of the chronograph hand overlap with each other, and a driving timing signal changing unit configured to perform, when it is determined that the driving timing signal of the time-of-day hand and the driving timing signal of the chronograph hand overlap with each other, any one of transmitting a driving timing change request for delaying an output of the driving timing signal of the time-of-day hand to the time-of-day hand driving timing generating unit, transmitting a driving timing change request for delaying an output of the driving timing signal of the chronograph hand to the chronograph hand driving timing generating unit, or transmitting a driving timing change request for advancing the output of the driving timing signal of the time-of-day hand to the time-of-day hand driving timing generating unit.

Preferably, the electronic watch of the application includes an internal counter configured to repeatedly count the number of outputs of the reference clock per second at every second, a counted value reading unit configured to read a value counted by the internal counter when the driving timing signal of the chronograph hand is output, and a counted value storage configured to store a counted value of the internal counter which matches the driving timing of the time-of-day hand in advance, wherein the timing overlap determining unit compares the value counted by the internal counter, which is read by the counted value reading unit when the driving timing signal of the chronograph hand is output, with the counted value stored in the counted value storage unit in advance and, if they match, determines that the driving timing signal of the time-of-day hand and the driving timing signal of the chronograph signal overlap with each other.

In the electronic watch of the application, the driving timing signal changing unit transmits a driving timing change request for delaying or advancing by a time not shorter than a sum of the time of the pulse width of the driving timing signal of the time-of-day hand and the time of the pulse width of the driving timing signal of the chronograph hand, but shorter than a time calculated by subtracting the pulse width of the driving timing signal of the time-of-day hand or the pulse width of the driving timing signal of the chronograph hand from a time of the transmission interval of the driving timing signals of the chronograph hand.

The application also provides a method of processing an electronic watch including a plurality of hands and a plurality of motors configured to move the hands respectively, including: outputting a reference clock indicating a reference of the movement of the hand at a reference cycle on the basis of the number of the reference cycles per second by a reference clock output unit, outputting a driving timing signal of a time-of-day hand among the plurality of hands at every time-of-day driving cycle on the basis of the reference clock by a time-of-day hand driving timing generating unit, detecting an action starting signal of a chronograph hand among the plurality of hands by an action detection unit; outputting the driving timing signal of the chronograph hand at every chronograph driving cycle on the basis of the reference clock by a chronograph hand driving timing generating unit after the detection of the action starting signal, determining whether or not the driving timing signal of the time-of-day hand and the driving timing signal of the chronograph hand overlap with each other by a timing overlap determining unit, and, when it is determined that the driving timing signal of the time-of-day hand and the driving timing signal of the chronograph hand overlap with each other, performing any one of transmitting a driving timing change request for delaying an output of the driving timing signal of the time-of-day hand to the time-of-day hand driving timing generating unit, transmitting a driving timing change request for delaying an output of the driving timing signal of the chronograph hand to the chronograph hand driving timing generating unit, or transmitting a driving timing change request for advancing the output of the driving timing signal of the time-of-day hand to the time-of-day hand driving timing generating unit by a driving timing signal changing unit.

The application also provides a program causing a computer of an electronic watch having a plurality of hands and a plurality of motors configured to move the hands respectively, to function as: a reference clock output unit configured to output a reference clock indicating a reference of the movement of the hand at a reference cycle on the basis of the number of the reference cycles per second, a time-of-day hand driving timing generating unit configured to output a driving timing signal of a time-of-day hand among the plurality of hands at every time-of-day driving cycle on the basis of the reference clock, an action detection unit configured to detect an action starting signal of a chronograph hand among the plurality of hands; a chronograph hand driving timing generating unit configured to output the driving timing signal of the chronograph hand at every chronograph hand driving cycle on the basis of the reference clock after the detection of the action starting signal, a timing overlap determining unit configured to determine whether or not the driving timing signal of the time-of-day hand and the driving timing signal of the chronograph hand overlap with each other, a driving timing signal changing unit configured to perform, when it is determined that the driving timing signal of the time-of-day hand and the driving timing signal of the chronograph hand overlap with each other, any one of transmitting a driving timing change request for delaying an output of the driving timing signal of the time-of-day hand to the time-of-day hand driving timing generating unit, transmitting a driving timing change request for delaying an output of the driving timing signal of the chronograph hand to the chronograph hand driving timing generating unit, or transmitting a driving timing change request for advancing the output of the driving timing signal of the time-of-day hand to the time-of-day hand driving timing generating unit.

According to the application, whether or not the driving timings of the time-of-day hand and the chronograph hand overlap each other is determined immediately after the detection of the start of the action of the chronograph and before the occurrence of the overlap and, if it is determined that they overlap, one of the time-of-day and the chronograph hand is shifted so as to avoid the overlap with the driving timing of the other one of those. Therefore, the fluctuation of the movement of the respective hands can be alleviated to improve the appearance irrespective of the instruction timing of the start of the action of the chronograph.

### BRIEF DESCRIPTION OF THE DRAWINGS

FIG. 1 is a first block diagram showing a functional configuration of an electronic watch;

FIG. 2 is a drawing showing a timing relationship of respective signals in the interior of the electronic watch before timing is changed;

FIG. 3 is a first drawing showing a timing relationship of respective signals in the interior of the electronic watch after the timing is changed;

FIG. 4 is a second drawing showing a timing relationship of respective signals in the interior of the electronic watch after the timing is changed;

FIG. 5 is a drawing showing an action flow of the electronic watch;

FIG. 6 is a second block diagram showing a functional configuration of the electronic watch; and

FIG. 7 is a third drawing showing a timing relationship of respective signals in the interior of the electronic watch after the timing is changed.

### DESCRIPTION OF THE PREFERRED EMBODIMENTS

Referring now to the drawings, an electronic watch according to a first embodiment of the invention will be described.

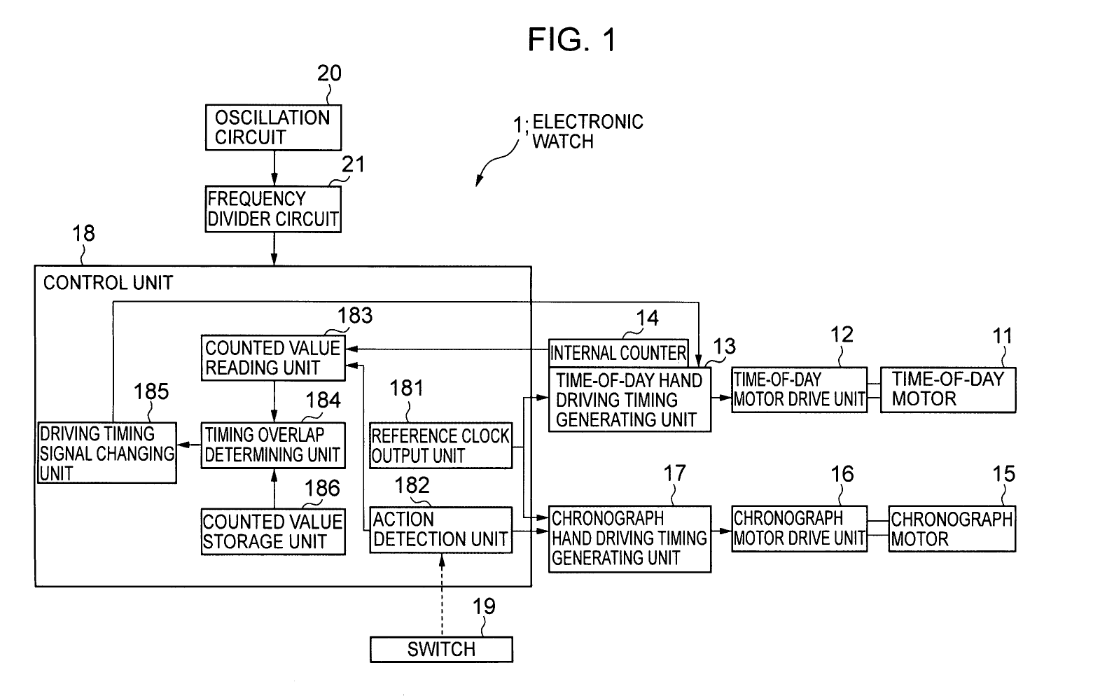

FIG. 1 is a first block diagram showing a functional configuration of the electronic watch according to the first embodiment.

In FIG. 1, reference numeral 1 designates an electronic watch. The electronic watch 1 includes a time-of-day motor 11 configured to drive time-of-day hands such as an hour hand, a minute hand, or a second hand, a time-of-day motor drive unit 12 configured to control the time-of-day motor 11, a time-of-day hand driving timing generating unit 13 configured to generate driving timing signals of the time-of-day hand at a time-of-day hand driving cycle, an internal counter 14 configured to count a reference clock, a chronograph motor 15 configured to drive a chronograph hand, a chronograph motor drive unit 16 configured to control the chronograph motor 15, a chronograph hand driving timing generating unit 17 configured to generate a driving timing signal of the chronograph hand, a control unit 18, a switch 19 operated by a user for inputting commands for starting or stopping an action of the chronograph hand, an oscillation circuit 20 configured to oscillate a signal at a frequency of 32,768 Hz per second, and a frequency divider circuit 21 configured to generate a time-of-day keeping clock signal at a predetermined frequency on the basis of the signal oscillated by the oscillation circuit 20.

The control unit 18 includes a reference clock output unit 181 configured to output a reference clock showing a reference of the movement of the hand at every reference cycle on the basis of the number of the reference cycles per second, an action detection unit 182 configured to detect the start of an action or the stop of an action of a chronograph function on the basis of the pressing of the switch 19, a counted value reading unit 183 configured to read values counted by the internal counter 14, a timing overlap determining unit 184 configured to determine whether or not the driving timing signal of the time-of-day hand and the driving timing signal of the chronograph hand overlap with each other, a driving timing signal changing unit 185 configured to transmit, when it is determined that the driving timing signal of the time-of-day hand and the driving timing signal of the chronograph hand overlap with each other, a driving timing change request for delaying an output of the driving timing signals of the time-of-day hand, advancing the output of the driving timing signal of the time-of-day hand, or delaying an output of the driving timing signal of the chronograph hand to the time-of-day hand driving timing generating unit, and a counted value storage unit 186 configured to store count values of the internal counter which match the driving timing of the time-of-day hand in advance.

Then, the electronic watch 1 according to the first embodiment compares a value counted by the internal counter, which is read by the counted value reading unit when the driving timing signal of the chronograph hand is output, with the counted value stored in the counted value storage unit 186 in advance and, if they match, determines that the driving timing signal of the time-of-day hand and the driving timing signal of the chronograph signal overlap with each other, and performs a process of delaying or advancing the driving timing of the time-of-day hand.

Accordingly, the electronic watch 1 according to the first embodiment performs an action of eliminating fluctuations of the movement of the hands.

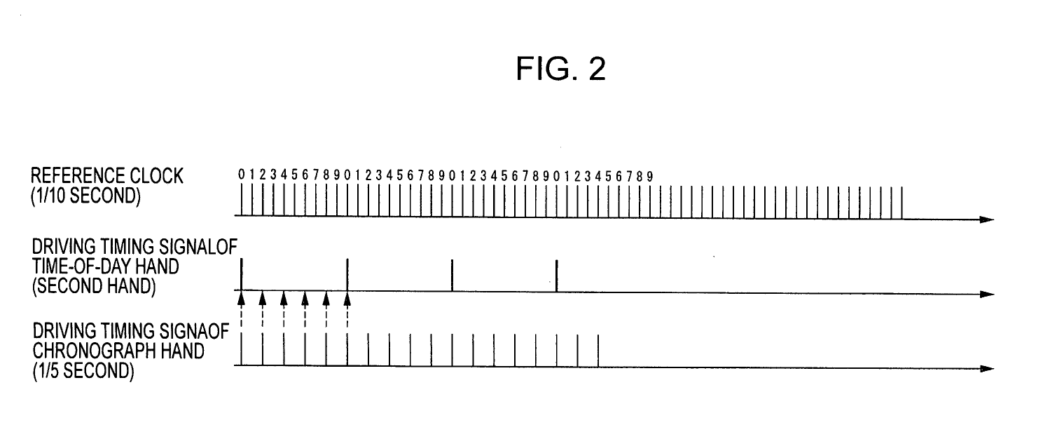

FIG. 2 is a drawing showing a timing relationship of respective signals in the interior of the electronic watch before the timing is changed.

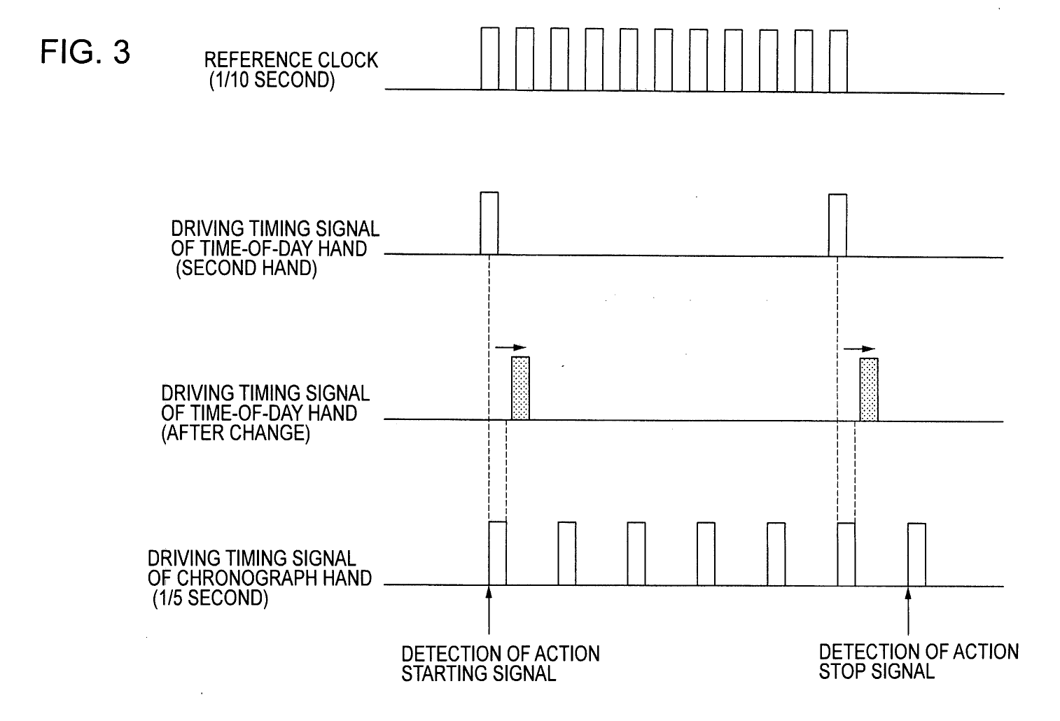

FIG. 3 is a first drawing showing a timing relationship of the respective signals in the interior of the electronic watch after the timing is changed.

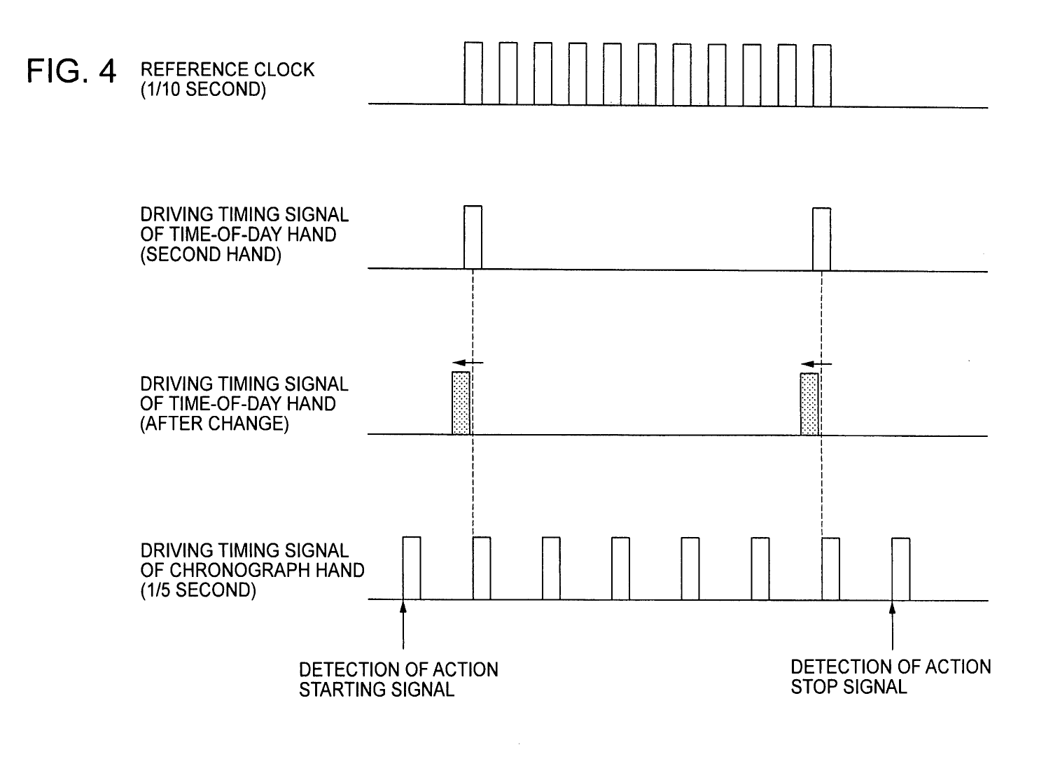

FIG. 4 is a second drawing showing a timing relationship of the respective signals in the interior of the electronic watch after the timing is changed.

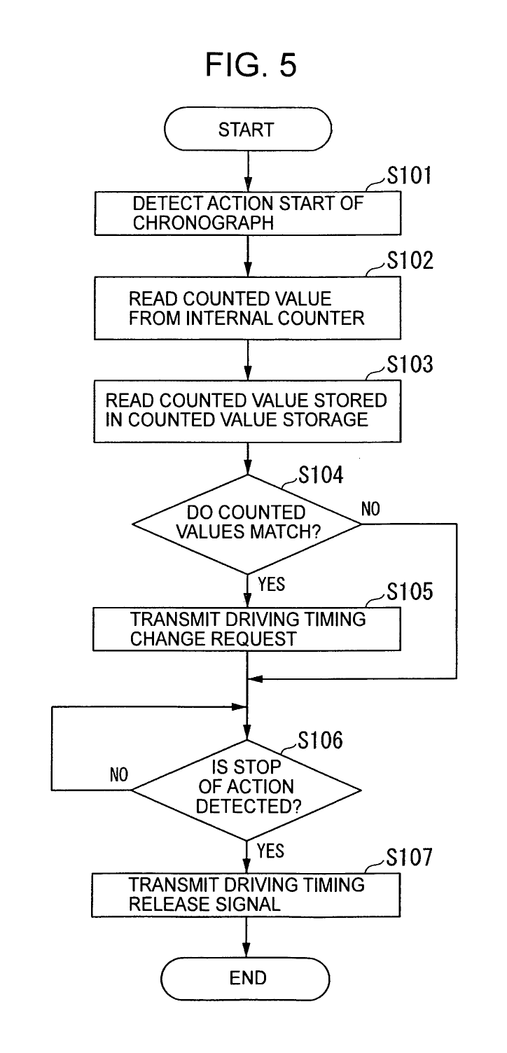

FIG. 5 is a drawing showing an action flow of the electronic watch.

Referring now to FIG. 2 to FIG. 5, detailed actions of the electronic watch 1 will be described.

In the electronic watch 1, first of all, the frequency divider circuit 21 generates a time-of-day keeping clock signal on the basis of a frequency oscillated by the oscillation circuit 20. Then, on the basis of the generated signal, the reference clock output unit 181 outputs a reference clock which is repeated every 1/10 second, for example, as shown in FIG. 2. When the reference clock is input to the time-of-day hand driving timing generating unit 13, if it is for the second hand, the time-of-day hand driving timing generating unit 13 outputs a time-of-day hand driving timing signal once per ten inputs of the reference clock. In a case where the reference clock is output repeatedly every 1/1000 second, if it is for the second hand, the time-of-day hand driving timing generating unit 13 outputs the time-of-day hand driving timing signal once in an input period of the first to the hundredth reference clock out of thousand inputs of the reference clock within a second (it is also possible to configure the time-of-day hand driving timing generating unit 13 to output the time-of-day hand driving timing signal once in an input period of the 101st to the 200th reference clock instead of the input period of the first time to the hundredth reference clock). In such a state, when the action detection unit 182 detects the start of the action of the chronograph by the switch 19 pressed by the user (Step S101), the action detection unit 182 outputs an action starting signal to the chronograph hand driving timing generating unit 17 or the counted value reading unit 183.

Then, the counted value reading unit 183 reads counted value from the internal counter 14 (Step S102). Here, the counted value counted by the internal counter 14 is the number of the reference clocks per second when the reference clocks output from the reference clock output unit 181 is input in the time-of-day hand driving timing generating unit 13, which is counted repeatedly every second. In other words, when the reference clock output unit 181 outputs the reference clock every 1/10 second, the internal counter 14 counts from 0 to 9 per second and repeats this counting every second. The value counted by the internal counter 14 when the start of the action is detected is read by the counted value reading unit 183. Then, the counted value reading unit 183 outputs the read counted value to the timing overlap determining unit 184. The timing overlap determining unit 184 then reads the counted value stored in the counted value storage unit 186 (Step S103). Then, the timing overlap determining unit 184 determines whether or not the counted value input from the counted value reading unit 183 matches the counted value read from the counted value storage unit 186 (Step S104). If the counted values match, the timing overlap determining unit 184 determines that the action timing of the time-of-day hand matches the action timing of the chronograph hand.

Here, the driving timing of the time-of-day hand (one second in the case of the second hand) and the driving timing of the chronograph hand (⅕ second in the first embodiment) are predetermined timings, and the driving timing of the chronograph hand is counted on the basis of the driving timing of the reference clock. Therefore, among the counted values of the reference clock counted by the internal counter 14, it is possible to find at which count the counted values counted at the same time of the day when the first driving timing signal of the chronograph hand is output upon the receipt of the action starting signal, match the driving timing of the time-of-day hand. For example, if the driving timing signal of the time-of-day hand is output every second and the driving timing signal of the chronograph hand is output every ⅕ second as in the first embodiment, when the first driving timing signal of the chronograph hand is output upon the reception of the action starting signal when counting the even-numbered counted values, namely, 0, 2, 4, 6, 8 among the counted values 0 to 9 of the reference clock output every 1/10 second, the driving timing of the chronograph hand and the driving timing of the time-of-day hand match. Therefore, counted values of the reference clock counted by the internal counter 14, which are known in advance to be the counted value at which the driving timings of the chronograph and the time-of-day hand match, are stored in the counted value storage unit 186 in advance. Then, as shown in FIG. 2, if the first driving timing signal of the chronograph hand on the basis of the action starting signal is output at the same time of the day with the counting time of the day of any one of the counted values 0, 2, 4, 6, 8 of the reference clock counted by the internal counter 14, that is, if the counted value input from the counted value reading unit 183 and the counted value read from the counted value storage unit 186 match, the timing overlap determining unit 184 determines that the action timing of the time-of-day hand and the action timing of the chronograph hand match.

When it is determined that the action timing of the time-of-day hand and the action timing of the chronograph hand match, the timing overlap determining unit 184 outputs an instruction to change the timing signal to the driving timing signal changing unit 185. Then, the driving timing signal changing unit 185 transmits a driving timing change request for delaying the output of the driving timing signal of the time-of-day hand to the time-of-day hand driving timing generating unit 13 (Step S105). Then, the time-of-day hand driving timing generating unit 13 outputs the time-of-day hand driving timing signal delayed by a predetermined time as shown in FIG. 3. Here, the predetermined time to be delayed may be selected arbitrarily, for example, in a range not shorter than a sum of the time of the pulse width of the driving timing signal of the time-of-day hand and the time of the pulse width of the driving timing signal of the chronograph hand but shorter than a time calculated by subtracting the pulse width of the driving timing signal of the time-of-day hand from a transmission interval of the driving timing signals of the chronograph hand.

In contrast, if it is determined that the action timing of the time-of-day hand does not match the action timing of the chronograph hand in Step S104, detection of the stop of the action of the chronograph on the basis of the repressing of the switch 19 is waited. The action detection unit 182 determines whether or not the stop of the action is detected by the repressing of the switch 19 (Step S106) and, when the stop of the action is detected, the action detection unit 182 notifies the driving timing release for returning the output of the driving timing signal of the time-of-day hand to the driving timing signal changing unit 185 to an initial value. Then, the driving timing signal changing unit 185 outputs a driving timing releasing signal to the time-of-day hand driving timing generating unit 13 (Step S107). Accordingly, the time-of-day hand driving timing generating unit 13 releases the action for delaying the output of the driving timing signal of the time-of-day hand (if the action for delaying is not done because the timings do not match, discard the driving timing releasing signal is discarded), or outputs the driving timing signal for driving the time-of-day hand to the time-of-day hand motor drive unit 12 at a timing before the action of the chronograph hand.

As shown in FIG. 4, the control unit 18 may be configured to take an action to advance the driving timing of the time-of-day hand. In this case, if it is determined that the action timing of the time-of-day hand and the action timing of the chronograph hand match in Step S104, the driving timing signal changing unit 185 transmits a driving timing change request for advancing the output of the driving timing signal of the time-of-day hand to the time-of-day hand driving timing generating unit 13 in Step S105. Then, the time-of-day hand driving timing generating unit 13 outputs the time-of-day hand driving timing signal at a timing advanced by a predetermined time as shown in FIG. 4. Here, the predetermined time to be advanced may be selected arbitrarily, for example, in a range not shorter than a sum of the time of the pulse of the driving timing signal of the time-of-day hand and the time of the pulse width of the driving timing signal of the chronograph hand but shorter than a time calculated by subtracting the pulse width of the driving timing signal of the time-of-day hand from a transmission interval of the driving timing signals of the chronograph hand.

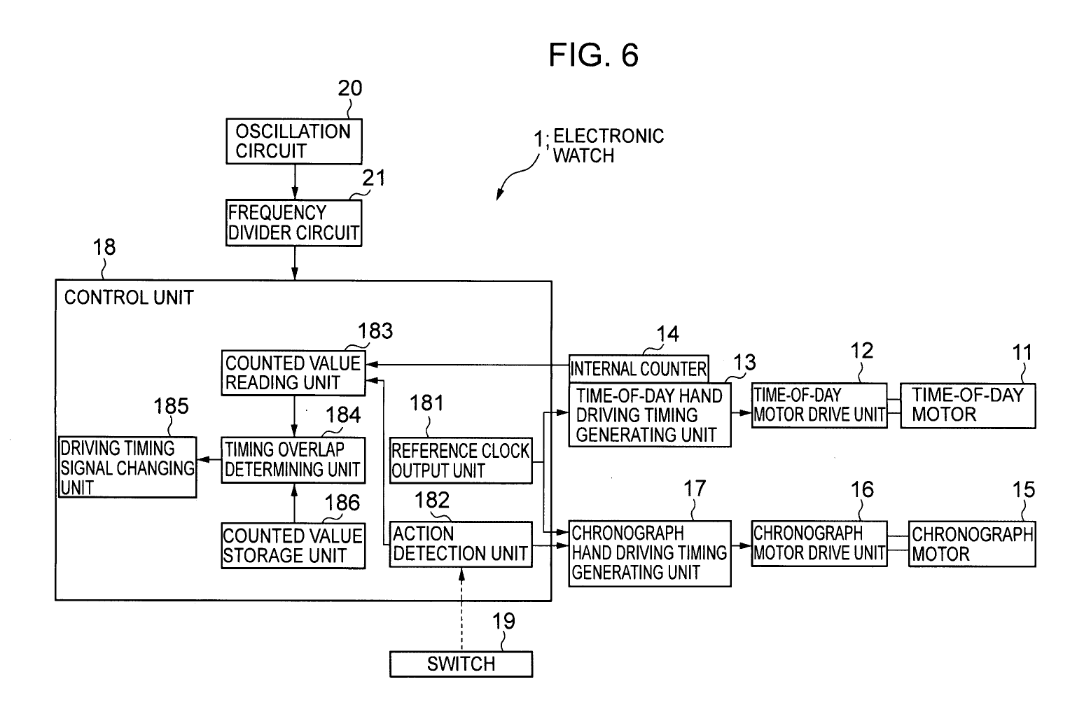

FIG. 6 is a second block diagram showing a functional configuration of the electronic watch according to the first embodiment.

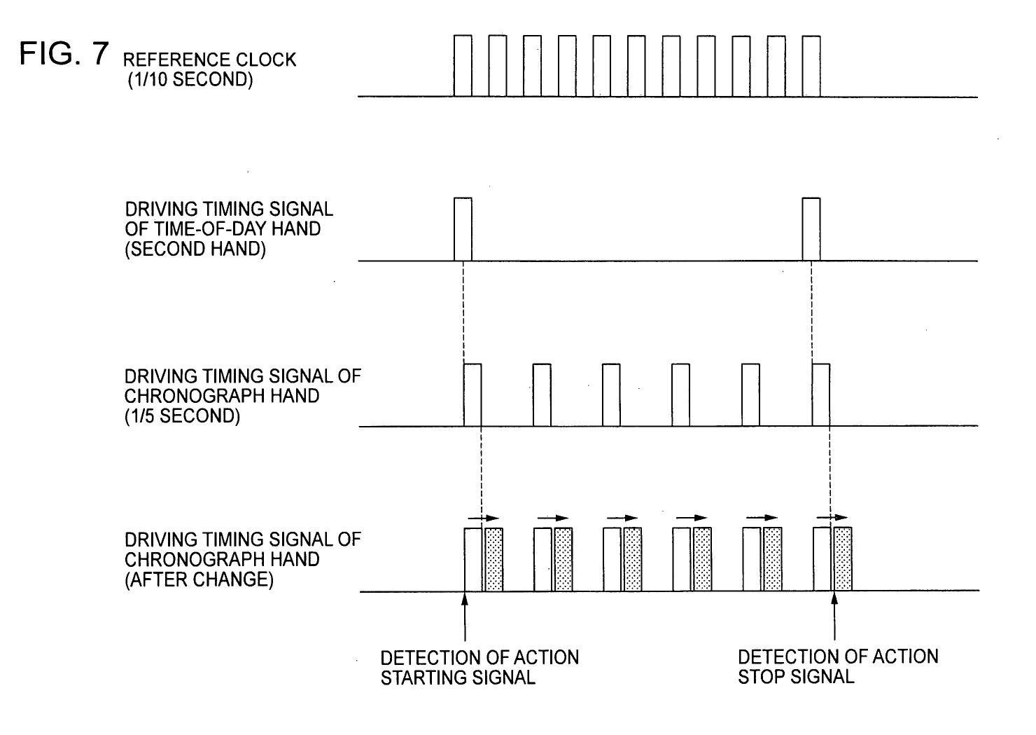

FIG. 7 is a third drawing showing the timing relationship of the respective signals in the interior of the electronic watch after the timing is changed.

The functional configuration of the electronic watch 1 shown in FIG. 6 is different from the functional configuration of the electronic watch 1 shown in FIG. 1 in that the output of the driving timing signal changing unit 185 is directed to the chronograph hand driving timing generating unit 17.

In this manner, the electronic watch 1 may be configured to delay the driving timing of the chronograph hand by outputting an output from the driving timing signal changing unit 185, that is, a driving timing change request to the chronograph hand driving timing generating unit 17. More specifically, when it is determined that the driving timing signal of the time-of-day hand and the driving timing signal of the chronograph hand overlap with each other in the above-described Step S104, the driving timing signal changing unit 185 transmits a driving timing change request for delaying the output of the driving timing signal of the chronograph hand to the chronograph hand driving timing generating unit 17 in Step S105. Then, the chronograph hand driving timing generating unit 17 outputs a driving timing signal of the chronograph hand delayed by a predetermined time as shown in FIG. 7. Here, the predetermined time to be delayed may be selected arbitrarily, for example, in a range not shorter than a sum of the time of the pulse width of the driving timing signal of the time-of-day hand and the time of the pulse width of the driving timing signal of the chronograph hand but shorter than a time calculated by subtracting the pulse width of the driving timing signal of the chronograph hand from a transmission interval of the driving timing signals of the chronograph hand.

With the process as described above, whether or not the driving timings of the time-of-day hand and the chronograph hand overlap is determined immediately after the detection of the start of the action of the chronograph and before the overlap occurs and, if it is determined that they overlap each other, one of the time-of-day and the chronograph hand is shifted so as to avoid the overlap. Therefore, the fluctuation of the movement of the respective hands can be alleviated to improve the appearance irrespective of the instruction timing of the start of the action of the chronograph.

According to the process as described above, if the counted value counted by the internal counter 14 when the start of the action of the chronograph is detected and the counted value recorded in the counted value storage unit 186 in advance match, it is determined that the driving timings of the time-of-day hand and the chronograph hand match. However, if the reference clock is output at a cycle of 1/1000 second, the reference clock is output from the reference clock output unit 181 a plurality of times within the time of the pulse width of the driving timing signal of the chronograph hand. For example, if the pulse width of the driving timing signal of the chronograph hand is 3 milliseconds, the reference clock is output three times at the time of the output of the driving timing signal. In such a case continuous counted values corresponding to the pulse width only have to be stored in the counted value storage unit 186 in advance. For example, if the reference clock is output at a cycle of 1/1000 second and the pulse width of the driving timing signal of the chronograph hand is 3 milliseconds, counted values of 0 to 3, 200 to 203, 400 to 403, 600 to 603, and 800 to 803 are stored in the counted value storage unit 186 in advance, and if the start of the action is detected at a time-of-day when the counting of the counted values is performed in the internal counter 14, it is determined that the driving timings of the time-of-day hand and the chronograph hand match.

The above-described electronic watch includes a computer system in the interior thereof. The courses of the respective processes described above are stored in a computer readable recording medium in the form of a program, and the above-described processes are performed by the computer reading out and executing the program. Here, the computer readable recording medium includes a magnetic disc, magneto-optical disk, CD-ROM, DVD-ROM, semiconductor memory, and the like.

The above-described program may be configured to realize part of the above-described functions. It may be a program which can be realized by combining the above-described function with a program stored already in the computer system, so called, a differential file (differential program).

What is claimed is:

1. An electronic watch having a plurality of hands and a plurality of motors configured to move the hands respectively, comprising:
a reference clock output unit configured to output a reference clock indicating a reference of the movement of the hand at a reference cycle on the basis of the number of the reference cycles per second,
a time-of-day hand driving timing generating unit configured to output a driving timing signal of a time-of-day hand among the plurality of hands at every time-of-day driving cycle on the basis of the reference clock,
an action detection unit configured to detect an action starting signal of a chronograph hand among the plurality of hands;
a chronograph hand driving timing generating unit configured to output a driving timing signal of the chronograph hand at every chronograph hand driving cycle on the basis of the reference clock after the detection of the action starting signal,
a timing overlap determining unit configured to determine whether or not the driving timing signal of the time-of-day hand and the driving timing signal of the chronograph hand overlap with each other, and
a driving timing signal changing unit configured to perform, when it is determined that the driving timing signal of the time-of-day hand and the driving timing signal of the chronograph hand overlap with each other, any one of transmitting a driving timing change request for delaying an output of the driving timing signal of the time-of-day hand to the time-of-day hand driving timing generating unit, transmitting a driving timing change request for delaying an output of the driving timing signal of the chronograph hand to the chronograph hand driving timing generating unit, or transmitting a driving timing change request for advancing the output of the driving timing signal of the time-of-day hand to the time-of-day hand driving timing generating unit.

2. An electronic watch according to claim 1, comprising:
an internal counter configured to repeatedly count the number of outputs of the reference clock per second, every second;
a counted value reading unit configured to read a value counted by the internal counter when the driving timing signal of the chronograph hand is output; and
a counted value storage configured to store a counted value of the internal counter in advance which matches the driving timing of the time-of-day hand, wherein
the timing overlap determining unit compares the value counted by the internal counter, which is read by the counted value reading unit when the driving timing signal of the chronograph hand is output, with a counted value stored in the counted value storage unit in advance and, if they match, determines that the driving timing signal of the time-of-day hand and the driving timing signal of the chronograph signal overlap with each other.

3. An electronic watch according to claim 1, wherein the driving timing signal changing unit transmits a driving timing change request for delaying or advancing by a time not shorter than a sum of the time of the pulse width of the driving timing signal of the time-of-day hand and the time of the pulse width of the driving timing signal of the chronograph hand, but shorter than a time calculated by subtracting the pulse width of the driving timing signal of the time-of-day hand or the pulse width of the driving timing signal of the chronograph hand from a time of the transmission interval of the driving timing signals of the chronograph hand.

4. An electronic watch according to claim 2, wherein the driving timing signal changing unit transmits a driving timing change request for delaying or advancing by a time not shorter than a sum of the time of the pulse width of the driving timing signal of the time-of-day hand and the time of the pulse width of the driving timing signal of the chronograph hand, but shorter than a time calculated by subtracting the pulse width of the driving timing signal of the time-of-day hand or the pulse width of the driving timing signal of the chronograph hand from a time of the transmission interval of the driving timing signals of the chronograph hand.

5. A method of processing an electronic watch including a plurality of hands and a plurality of motors configured to move the hands respectively, comprising:
outputting a reference clock indicating a reference of the movement of the hand at a reference cycle on the basis of the number of the reference cycles per second by a reference clock output unit;
outputting a driving timing signal of a time-of-day hand among the plurality of hands at every time-of-day driving cycle on the basis of the reference clock by a time-of-day hand driving timing generating unit;
detecting an action starting signal of a chronograph hand among the plurality of hands by an action detection unit;
outputting a driving timing signal of the chronograph hand at every chronograph driving cycle on the basis of the reference clock by a chronograph hand driving timing generating unit after the detection of the action starting signal;
determining whether or not the driving timing signal of the time-of-day hand and the driving timing signal of the chronograph hand overlap with each other by a timing overlap determining unit; and
performing, when it is determined that the driving timing signal of the time-of-day hand and the driving timing signal of the chronograph hand overlap with each other, any one of transmitting a driving timing change request for delaying an output of the driving timing signal of the time-of-day hand to the time-of-day hand driving timing generating unit, transmitting a driving timing change request for delaying an output of the driving timing signal of the chronograph hand to the chronograph hand driving timing generating unit, or transmitting a driving timing change request for advancing the output of the driving timing signal of the time-of-day hand to the time-of-day hand driving timing generating unit by a driving timing signal changing unit.

6. A program causing a computer of an electronic watch having a plurality of hands and a plurality of motors configured to move the hands respectively, to function as:
a reference clock output unit configured to output a reference clock indicating a reference of the movement of the hand at a reference cycle on the basis of the number of the reference cycles per second;
a time-of-day hand driving timing generating unit configured to output a driving timing signal of a time-of-day hand among the plurality of hands at every time-of-day driving cycle on the basis of the reference clock;
an action detection unit configured to detect an action starting signal of a chronograph hand among the plurality of hands;
a chronograph hand driving timing generating unit configured to output a driving timing signal of the chronograph hand at every chronograph hand driving cycle on the basis of the reference clock after the detection of the action starting signal;
a timing overlap determining unit configured to determine whether or not the driving timing signal of the time-of-day hand and the driving timing signal of the chronograph hand overlap with each other;
a driving timing signal changing unit configured to perform, when it is determined that the driving timing signal of the time-of-day hand and the driving timing signal of the chronograph hand overlap with each other, any one of transmitting a driving timing change request for delaying an output of the driving timing signal of the time-of-day hand to the time-of-day hand driving timing generating unit, transmitting a driving timing change request for delaying an output of the driving timing signal of the chronograph hand to the chronograph hand driving timing generating unit, or transmitting a driving timing change request for advancing the output of the driving timing signal of the time-of-day hand to the time-of-day hand driving timing generating unit.
